(19) United States
(12) Patent Application Publication
(10) Pub. No.: US 2018/0147655 A1
(43) Pub. Date: May 31, 2018

(54) ADDITIVE MANUFACTURING OF THREE-DIMENSIONAL ARTICLES

(71) Applicant: ARCAM AB, Moelndal (SE)

(72) Inventor: Ulf Ackelid, Goeteborg (SE)

(21) Appl. No.: 15/788,976

(22) Filed: Oct. 20, 2017

Related U.S. Application Data
(60) Provisional application No. 62/427,932, filed on Nov. 30, 2016.

(51) Int. Cl. B23K 15/00; B33Y 10/00; B33Y 30/00; B33Y 50/02; B22F 3/15; B23K 15/06; B23K 15/02

(52) U.S. Cl. CPC B23K 15/0086; B33Y 10/00; B33Y 30/00; B23K 15/004; B22F 3/15; B23K 15/06; B23K 15/02; B33Y 50/02

(57) ABSTRACT

Provided is a method for forming a three-dimensional article through successively depositing individual layers of powder material that are fused together so as to form the article in a vacuum chamber, said method comprising the steps of: providing at least one electron beam source emitting an electron beam for at least one of heating or fusing said powder material in said vacuum chamber, applying a first set of beam parameters for formation of a fused bulk material of said three-dimensional article, where said bulk material has a predetermined microstructure, applying a second set of beam parameters for formation of a top portion of said three-dimensional article, wherein said second set of beam parameters is applied a predetermined number of layers prior to reaching a top surface of said three-dimensional article for encapsulating chimney porosities into said bulk material. Associated apparatus and computer program product are also provided.

### CROSS-REFERENCE TO RELATED APPLICATIONS

This application claims priority to and the benefit of U.S. Provisional Patent Application Ser. No. 62/427,932, filed Nov. 30, 2016, the contents of which as are hereby incorporated by reference in their entirety.

### BACKGROUND

### Related Field

The present invention relates to a method for additive manufacturing of a three-dimensional articles by successively fusing individual layers of powder material.

### Description of Related Art

Free-form fabrication or additive manufacturing is a method for forming three-dimensional articles through successive fusion of chosen parts of powder layers applied to a worktable.

An additive manufacturing apparatus may comprise a work table on which the three-dimensional article is to be formed, a powder dispenser or powder distributor, arranged to lay down a thin layer of powder on the work table for the formation of a powder bed, a high energy beam for delivering energy to the powder whereby fusion of the powder takes place, elements for control of the energy given off by the energy beam over the powder bed for the formation of a cross section of the three-dimensional article through fusion of parts of the powder bed, and a controlling computer, in which information is stored concerning consecutive cross sections of the three-dimensional article. A three-dimensional article is formed through consecutive fusions of consecutively formed cross sections of powder layers, successively laid down by the powder dispenser. In electron beam melting (EBM) said high energy beam is one or a plurality of electron beams.

In additive manufacturing a short manufacturing time and high quality of the finalized product is of outmost importance. Desired material properties of the final product may depend on the ability to control the heating and/or fusion process. A specific microstructure may need a specific setting of the heating and/or fusion process. However, certain setting of the heating and/or fusion process in order to achieve a predetermined microstructure may introduce porosities in the final product which may not be possible to remove in a post Hot Isostatic Pressing (HIP) process step which in turn may render the manufactured part worthless.

### BRIEF SUMMARY

An object of the invention is to provide a method which fast and accurately improves heating and/or fusion process in an additive electron beam melting manufacturing process for improving the material characteristics of the manufactured 3-dimensional article at the same time as making a HIP-process an efficient post treatment for removing potential porosities in the final product.

The above mentioned object is achieved by the features in the method according to claim 1. In this respect, in a first aspect of the invention it is provided a method for forming a three-dimensional article through successively depositing individual layers of powder material that are fused together so as to form the three-dimensional article in a vacuum chamber, said method comprising the steps of: providing at least one electron beam source emitting an electron beam for at least one of heating or fusing said powder material in said vacuum chamber, applying a first set of beam parameters for formation of a fused bulk material of said three-dimensional article, where said bulk material of said three-dimensional article is having a predetermined microstructure, and applying a second set of beam parameters for formation of a top portion of said three-dimensional article, wherein said second set of beam parameters has a higher power per unit time and unit area than said first set of beam parameters and is applied a predetermined number of layers prior to reaching a top surface of said three-dimensional article for encapsulating chimney porosities into said bulk material.

A non-limiting advantage of this embodiment is that chimney porosities that may start from within the three-dimensional article will be closed by the inventive method and may thereby be possible to remove in a following HIP process step which would not have been possible if said chimney porosity would have an open end at the top surface of the three-dimensional article.

In various example embodiments of the present invention said beam parameters may be at least one of a group of: beam focus, beam scanning speed, beam line offset, beam power, beam on-off switching frequency.

A non-limiting advantage of these embodiments is that there is a great variety of parameters to adjust in order to achieve the desired result meaning that the machine operator may have several alternatives for making sure any porosity that may be present will stay within the bulk material of said three-dimensional article.

In various example embodiments of the present invention a first electron beam source may be used for melting the bulk material and a second electron beam source is used for melting said top surface and said predetermined layers prior to said top surface.

A non-limiting advantage of these embodiments is that one different electron beam sources may be optimized for different purpose, i.e., a first one may be optimized for achieving desired microstructures within the bulk material of said three-dimensional article, whereas a second one may be optimized for a higher beam power per unit time and unit area compared with the first one.

In various example embodiments of the present invention said predetermined number of layers prior to said top surface may be less than 10 layers.

A non-limiting advantage of these embodiments is that the thickness of said predetermined layers may be thin enough to fall within the thickness of material that will nevertheless be machined away from the final three-dimensional product.

In various example embodiments of the present invention the same or different beam parameters may be used for said top surface and all said predetermined layers prior to said top surface.

A non-limiting advantage of these embodiments is that the powder per unit time and unit area may be changed depending on the presence or lack of porosities. If porosities are still present after having melted one or a plurality of said predetermined layers prior to said top surface, said powder per unit time and unit area may be further increased in order to make sure to close said porosity(ies).

In various example embodiments of the present invention a first electron beam source may be used for melting bulk material and an additional melting source, such as a resistive heat source, IR heat source or a laser beam source may be used alone or in combination with said first electron beam source, for melting said top surface and said predetermined layers prior to said top surface.

A non-limiting advantage of these embodiments is that said additional source may be an inexpensive power booster with the only purpose of increasing the inputted energy into the powder material.

In various example embodiments of the present invention a first electron beam source may be emitting a continuous electron beam and a second electron beam source may be emitting a pulsed electron beam.

A non-limiting advantage of these embodiments is that the microstructure may be tailor-made for achieving a predetermined microstructure inside the bulk material whereas the continuous beam is used for delivering sufficient power per unit time and unit area for making sure to remove any porosity in a specific fused powder layer.

In various example embodiments said first electron beam source may be emitting a pulsed electron beam with a first frequency and said second electron beam source may be emitting an electron beam source with a second frequency.

A non-limiting advantage of this embodiment is that said first and second electron beam sources may be set to work synchronously in order to increase the powder per unit time and unit area or non-synchronously for customize the microstructure of the fused powder layer.

All examples and exemplary embodiments described herein are non-limiting in nature and thus should not be construed as limiting the scope of the invention described herein. Still further, the advantages described herein, even where identified with respect to a particular exemplary embodiment, should not be necessarily construed in such a limiting fashion.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 depict cross sectional side view of an example embodiment of an additively manufactured three-dimensional article; and

FIG. 2 depicts, in a schematic view, an example embodiment of an apparatus for producing three-dimensional articles, which may have the inventive method according to the present invention implemented into it;

FIG. 3 depicts schematically a flow chart of an example embodiment of the method according to the present invention;

FIG. 4 is a block diagram of an exemplary system 1020 according to various embodiments;

FIG. 5A is a schematic block diagram of a server 1200 according to various embodiments; and

FIG. 5B is a schematic block diagram of an exemplary mobile device 1300 according to various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Still further, to facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “three-dimensional structures” and the like as used herein refer generally to intended or actually fabricated three-dimensional configurations (e.g., of structural material or materials) that are intended to be used for a particular purpose. Such structures, etc. may, for example, be designed with the aid of a three-dimensional CAD system.

The term “electron beam” as used herein in various embodiments refers to any charged particle beam. The sources of charged particle beam can include an electron gun, a linear accelerator and so on.

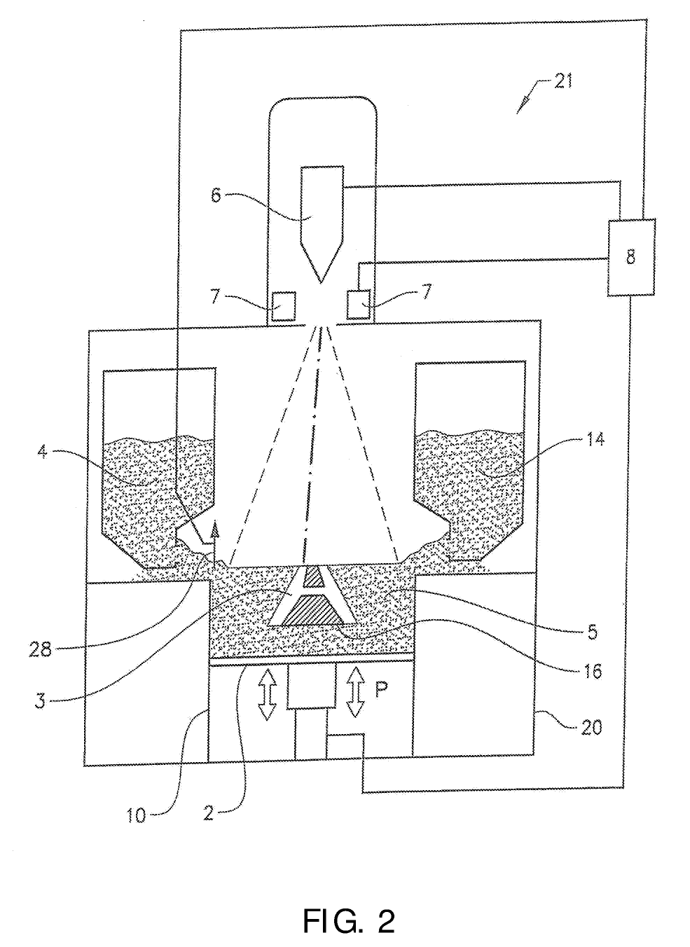

FIG. 2 depicts an embodiment of a freeform fabrication or additive manufacturing apparatus 21 in which the inventive method according to the present invention may be implemented.

The apparatus 21 comprising an electron beam source 6; deflection coils 7; two powder hoppers 4, 14; a build platform 2; a build tank 10; a powder distributor 28; a powder bed 5; and a vacuum chamber 20.

The vacuum chamber 20 is capable of maintaining a vacuum environment via a vacuum system, which system may comprise a turbo molecular pump, a scroll pump, an ion pump and one or more valves which are well known to a skilled person in the art and therefore need no further explanation in this context. The vacuum system is controlled by a control unit 8.

The electron beam source 6 is generating an electron beam which is used for pre heating of the powder, melting or fusing together powder material provided on the build platform 2 or post heat treatment of the already fused powder material. The control unit 8 may be used for controlling and managing the electron beam emitted from the electron beam source 6. At least one focusing coil (not shown), at least one deflection coil 7, an optional coil for astigmatic correction (not shown) and an electron beam power supply (not shown) may be electrically connected to the control unit 8. In an example embodiment of the invention the electron beam source 6 may generate a focusable electron beam with variable accelerating voltage of about 5-100 kV and with a beam power in the range of 2-15 kW. The pressure in the vacuum chamber may be 1×10⁻³ mbar or lower when building the three-dimensional article by fusing the powder layer by layer with the energy beam.

The powder hoppers 4, 14 comprise the powder material to be provided on the build platform 2 in the build tank 10. The powder material may for instance be pure metals or metal alloys such as titanium, titanium alloys, aluminum, aluminum alloys, stainless steel, Co—Cr alloys, nickel based super alloys, etc.

The powder distributor 28 is arranged to lay down a thin layer of the powder material on the build platform 2. During a work cycle the build platform 2 will be lowered successively in relation to a fixed point in the vacuum chamber. In order to make this movement possible, the build platform 2 is in one embodiment of the invention arranged movably in vertical direction, i.e., in the direction indicated by arrow P. This means that the build platform 2 starts in an initial position, in which a first powder material layer of necessary thickness has been laid down. Means for lowering the build platform 2 may for instance be through a servo engine equipped with a gear, adjusting screws, etc. The servo engine may be connected to the control unit 8.

An electron beam may be directed over the build platform 2 causing the first powder layer to fuse in selected locations to form a first cross section of the three-dimensional article 3.

The beam may be directed over the build platform 2 from instructions given by the control unit 8. In the control unit 8 instructions for how to control the electron beam for each layer of the three-dimensional article may be stored. The first layer of the three dimensional article 3 may be built on the build platform 2, which may be removable, in the powder bed 5 or on an optional start plate 16. The start plate 16 may be arranged directly on the build platform 2 or on top of a powder bed 5 which is provided on the build platform 2.

After a first layer is finished, i.e., the fusion of powder material for making a first layer of the three-dimensional article, a second powder layer is provided on the build platform 2. The thickness of the second layer may be determined by the distance the build platform is lowered in relation to the position where the first layer was built. The second powder layer is in various embodiments distributed according to the same manner as the previous layer. However, there might be alternative methods in the same additive manufacturing machine for distributing powder onto the work table. For instance, a first layer may be provided via a first powder distributor 28, a second layer may be provided by another powder distributor. The design of the powder distributor is automatically changed according to instructions from the control unit 8. A powder distributor 28 in the form of a single rake system, i.e., where one rake is catching powder fallen down from both a left powder hopper 4 and a right powder hopper 14, the rake as such can change design.

After having distributed the second powder layer on the build platform, the energy beam is directed over the work table causing the second powder layer to fuse in selected locations to form a second cross section of the three-dimensional article. Fused portions in the second layer may be bonded to fused portions of the first layer. The fused portions in the first and second layer may be melted together by melting not only the powder in the uppermost layer but also remelting at least a fraction of a thickness of a layer directly below the uppermost layer.

The powder may be allowed to be slightly sintered during a pre-heating process. Said pre-heating process is taking place before the actual fusing of the powder material in order to create a predetermined cross section of the three-dimensional article. The preheating may be performed in order to increase the conductivity of the powder material and/or to increase the working temperature of the powder material to be within a predetermined temperature range.

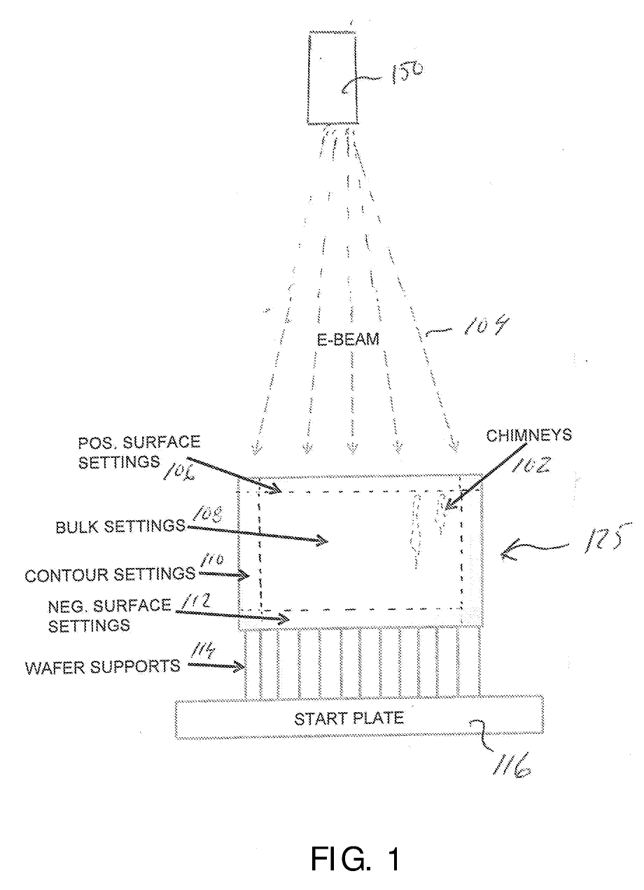

FIG. 1 depicts a cross sectional side view of an example embodiment of an additively manufactured three-dimensional article 125 with electron beams 104. The three-dimensional article 125 may be built on wafer supports 114 which in turn may be attached onto a start plate 116. The wafer support may be used for heat transfer from the thee-dimensional article and/or support for negative surfaces. The starting layers or negative surface 112 of the three-dimensional article 125 may be fused with negative surface settings of the electron beam source 150. The contour 110 of the three-dimensional article 125 in an x-y plane may be fused with contour settings. A positive surface or top surface 106 may be fused with positive surface settings of the electron beam source 150. A bulk 108 of the three-dimensional article may be fused with bulk settings. The bulk settings of the electron beam source may be chosen so as to achieve a desired microstructure of the fused material of the bulk 108 of the three-dimensional article. The positive surface and a predetermined layers prior to said positive surface may be fused with positive surface settings of the electron beam source so as to slightly overmelt the powder material in order to close chimney porosities 102 that may be present inside the bulk 108 of the three-dimensional article 125. Overmelting means a higher beam power per unit area and unit time compared to the beam power used for melting the bulk of the three-dimensional article 125. The negative surface may use a lower beam power per unit area and unit time compared to the bulk material. A negative surface setting of the energy beam source may typically last less than 20 powder layers. The settings for all said negative surface layers may be equal or different. If different the beam power per unit time and unit area may be increased for layers further away from the negative surface. The beam power may be increased exponentially, linear or according to any chosen mathematical formula.

However, due to imperfections in the build process such as powder layer distribution and/or electron beam spot accuracy and/or electron beam position accuracy and/or electron beam power accuracy, defects may start to build from the bulk 108 of the three-dimensional article. Since the electron beam source settings may be chosen so as to achieve a desired microstructure such electron beam settings are insufficient to heal or stop such defects which may originate inside the three-dimensional article. The contour 110 of the three-dimensional article 125 may have a different setting of the electron beam source compared to the bulk. The contour setting may for instance have a smaller spot size of the electron beam in order to increase the dimension accuracy of the three-dimensional article, i.e., the spot size in the bulk area is not as critical as it may be when melting the outer shape of the three-dimensional article.

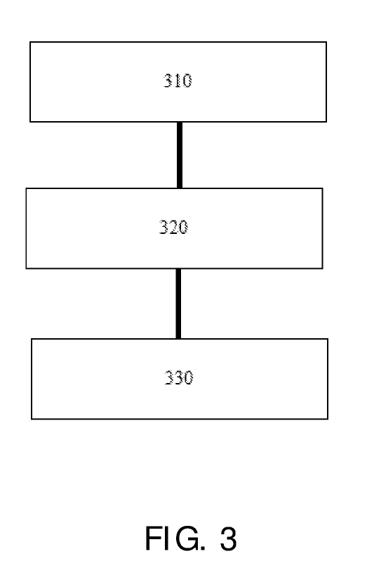

FIG. 3 depicts schematically a flow chart of an example embodiment of the method for forming a three-dimensional article through successively depositing individual layers of powder material that are fused together so as to form the article in a vacuum chamber.

In a first step 310 at least one electron beam source is provided for emitting an electron beam for at least one of heating or fusing said powder material in said vacuum chamber.

In a second step 320 a first set of beam parameters is applied for formation of a fused bulk material of said three-dimensional article, where said bulk material of said three-dimensional article is having a predetermined microstructure. In electron beam melting (EBM) the process parameters may be optimized to give dense material under ideal conditions. However, some pores may still appear due to irregularities in one or several subsystems such as improper powder distribution resulting in an irregular powder layer and/or deviations in electron beam spot and/or electron beam position accuracy. When manufacturing three-dimensional articles with EBM so called chimneys may appear in the final article. If a pore is created inside the bulk in one layer, then this pore may survive through several consecutive layers, even if the melting process is working properly. The melting process in order to achieve desired microstructures do not have enough power to heal/remove a defect once it has appeared. In FIG. 1, a chimney is denoted with 102. Chimneys typically grow in a vertical direction, i.e., in a direction essentially perpendicular to the start plate 116.

Three-dimensional articles manufactured with EBM may be fully accepted although porosities may be present in the final product as long as said porosities show up in the bulk material. Porosities in the bulk material may be closed in a HIP process after said three-dimensional article has been finalized. However, porosities like chimneys is a problem because if they are allowed to grow all the way to the top surface then they cannot be removed in a post HIP process step.

According to the present invention we have found experimentally that such chimneys may nevertheless be removed in a post HIP process if the top surface or positive surface of the three-dimensional article is slightly overmelted for allowing said chimney(s) to be closed.

In a third step 330 according to the present invention a second set of beam parameters is applied for formation of a top portion of said three-dimensional article, wherein said second set of beam parameters has a higher power per unit time and unit area than said first set of beam parameters and is applied a predetermined number of layers prior to reaching a top surface of said three-dimensional article for encapsulating chimney porosities into said bulk material.

In an example embodiment of the present invention a power of said electron beam per unit area and unit time for said second set of parameters is between 50-200% higher than said first set of parameters.

In another example embodiment of the present invention the power of said electron beam per unit area and unit time for said second set of parameters is twice as high as said first set of parameters.

A HIP process may be used for removing cavities, such as chimneys, in said finalized three-dimensional article. Standard HIPing conditions may be applied which means for Ti-6A1-4V a temperature of 920° C. combined with a pressure of 100 MPa (applied via argon gas) for 2 hours, followed by a cooling to room temperature at a rate of 6±2 K/min. Different materials obviously have different standard HIPing conditions for removing internal cavities.

From experiment we have confirmed that up to 8% chimney porosities can be removed in a post HIP process step if said chimneys are within the bulk material of the three dimensional article, i.e., no chimneys will have an open end at the top surface of the three-dimensional article.

The beam parameters that may be varied for varying the power of said electron beam per unit area and unit time may be at least one of a group of: beam focus, beam scanning speed, beam line offset, beam current, beam on-off switching frequency. One or several of these parameters may be changed from said first set of beam parameters and said second set of beam parameters.

Said beam parameters may be changed less than 10 layers prior to said top surface or positive surface for slightly overmelting the powder material. This overmelting will close any chimney porosities and create a 100% dense top surface so that said chimney porosities will remain inside the bulk material and not reach to the top surface. After HIPing said chimneys may be removed and the three-dimensional article will be 100% dense. Different materials may need more or less layers prior to said top surface with said second beam parameters and the difference between said first and second beam parameters may also differ between different materials in said three-dimensional article. The number of layers used with said second beam parameters may also be adjusted depending on how much porosities have been detected. More porosities may need more layers prior to said top surface with said second parameters than a three-dimensional article with very little porosity. The degree of porosity may for instance be detected by a heat imaging or by x-ray imaging.

A first electron beam source may be used for melting the bulk material and a second electron beam source may be used for melting said top surface and said predetermined layers prior to said top surface. Alternatively, a single source is used in which the beam parameters is changed depending on which part of the three-dimensional article is fused. As a further alternative two or more electron beam sources may be used simultaneously for melting said top surface and said predetermined layers prior to said top surface.

As an alternative to or a combination of the second set of beam parameters for forming the top surface, said positive surface and a predetermined number prior to said positive surface may be melted multiple times, i.e., the energy beam spot is first melting the powder material and in a next step remelts the already fused powder layer one or several times in order to make sure to remove any porosities that may be present in the last formed layer of the three-dimensional article.

The one and the same beam parameters may be used for said top surface and all said predetermined layers prior to said top surface. Alternatively, different beam parameters may be used for said top layer and said predetermined layers prior to said top surface. In case of different beam parameters for said top layer and said predetermined layers prior to said top layer, said second beam parameters may start with, i.e., the layer closest to the bulk material, a first beam power per unit area and unit time compared to said second beam parameters closer to the top surface which may have a second beam power per unit time and unit area. Said first beam powder per unit time and unit area may be higher than said second beam power per unit time and unit area. Said second beam power per unit time and unit area may be higher than said the beam power used for melting the bulk portion of the three-dimensional article.

In an example embodiment said thickness of said top layer together with said predetermined layers may be less than the thickness that will be machined away from the three-dimensional article. Any change in material characteristics, as a result of said second beam parameters, of the outer surface will not affect the final material characteristics of the three-dimensional article since it is to be removed from the final three-dimensional article.

A first electron beam source may be used for melting bulk material and an additional melting source may be used for melting said top surface and said predetermined layers prior to said top surface. Said additional source may be a resistive source and/or an IR source and/or a laser source. The additional source may melt said top surface and said layers predetermined layers prior to said top surface alone or simultaneous with said electron beam source.

A first electron beam source may be emitting a continuous electron beam and a second electron beam source is emitting a pulsed electron beam. Said pulsed electron beam source may be used for fusing/heating said bulk material and said continuous electron beam source may be used for fusing/heating said top surface and said predetermined layers prior to said top surface.

Alternatively said pulsed and continuous electron beams may be emanating from one and the same electron beam source. The pulsed electron beams may be used for the bulk material and said continuous electron beam may be used for said top layer and said predetermined layers prior to said top layer.

A first electron beam source may be emitting a pulsed electron beam with a first frequency and said second electron beam source may be emitting a pulsed electron beam with a second frequency. Said first and second pulsed electron beams may be pulsed synchronously when melting said top surface and said predetermined layers prior to said top surface. Alternatively said first and said second electron beam sources may emit pulsed electron beams non-synchronously when melting said top surface and said predetermined layers prior to said top surface.

In another aspect of the invention it is provided a program element configured and arranged when executed on a computer to implement a method as detailed herein. The program element may be installed in a non-transitory computer readable storage medium. The computer readable storage medium may be the control unit 8 or on another control unit. The computer readable storage medium and the program element, which may comprise computer-readable program code portions embodied therein, may further be contained within a non-transitory computer program product. Further details in this regard are provided below.

As mentioned, various embodiments of the present invention may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magneto-resistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like, as have been described elsewhere herein. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

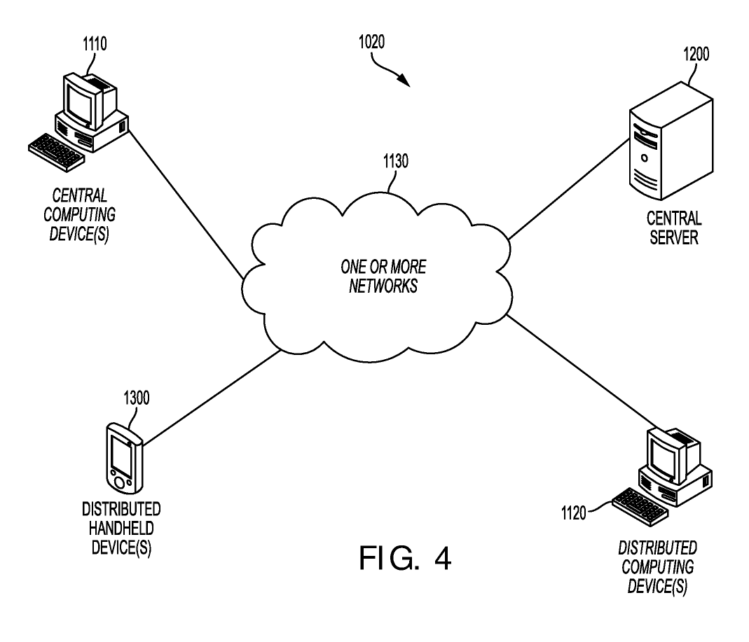

FIG. 4 is a block diagram of an exemplary system 1020 that can be used in conjunction with various embodiments of the present invention. In at least the illustrated embodiment, the system 1020 may include one or more central computing devices 1110, one or more distributed computing devices 1120, and one or more distributed handheld or mobile devices 1300, all configured in communication with a central server 1200 (or control unit) via one or more networks 1130. While FIG. 4 illustrates the various system entities as separate, standalone entities, the various embodiments are not limited to this particular architecture.

According to various embodiments of the present invention, the one or more networks 1130 may be capable of supporting communication in accordance with any one or more of a number of second-generation (2G), 2.5G, third-generation (3G), and/or fourth-generation (4G) mobile communication protocols, or the like. More particularly, the one or more networks 1130 may be capable of supporting communication in accordance with 2G wireless communication protocols IS-136 (TDMA), GSM, and IS-95 (CDMA). Also, for example, the one or more networks 1130 may be capable of supporting communication in accordance with 2.5G wireless communication protocols GPRS, Enhanced Data GSM Environment (EDGE), or the like. In addition, for example, the one or more networks 1130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 1020 may be configured to communicate with one another in accordance with techniques such as, for example, radio frequency (RF), Bluetooth™ infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the device(s) 1110-1300 are illustrated in FIG. 4 as communicating with one another over the same network 1130, these devices may likewise communicate over multiple, separate networks.

According to one embodiment, in addition to receiving data from the server 1200, the distributed devices 1110, 1120, and/or 1300 may be further configured to collect and transmit data on their own. In various embodiments, the devices 1110, 1120, and/or 1300 may be capable of receiving data via one or more input units or devices, such as a keypad, touchpad, barcode scanner, radio frequency identification (RFID) reader, interface card (e.g., modem, etc.) or receiver. The devices 1110, 1120, and/or 1300 may further be capable of storing data to one or more volatile or non-volatile memory modules, and outputting the data via one or more output units or devices, for example, by displaying data to the user operating the device, or by transmitting data, for example over the one or more networks 1130.

In various embodiments, the server 1200 includes various systems for performing one or more functions in accordance with various embodiments of the present invention, including those more particularly shown and described herein. It should be understood, however, that the server 1200 might include a variety of alternative devices for performing one or more like functions, without departing from the spirit and scope of the present invention. For example, at least a portion of the server 1200, in certain embodiments, may be located on the distributed device(s) 1110, 1120, and/or the handheld or mobile device(s) 1300, as may be desirable for particular applications. As will be described in further detail below, in at least one embodiment, the handheld or mobile device(s) 1300 may contain one or more mobile applications 1330 which may be configured so as to provide a user interface for communication with the server 1200, all as will be likewise described in further detail below.

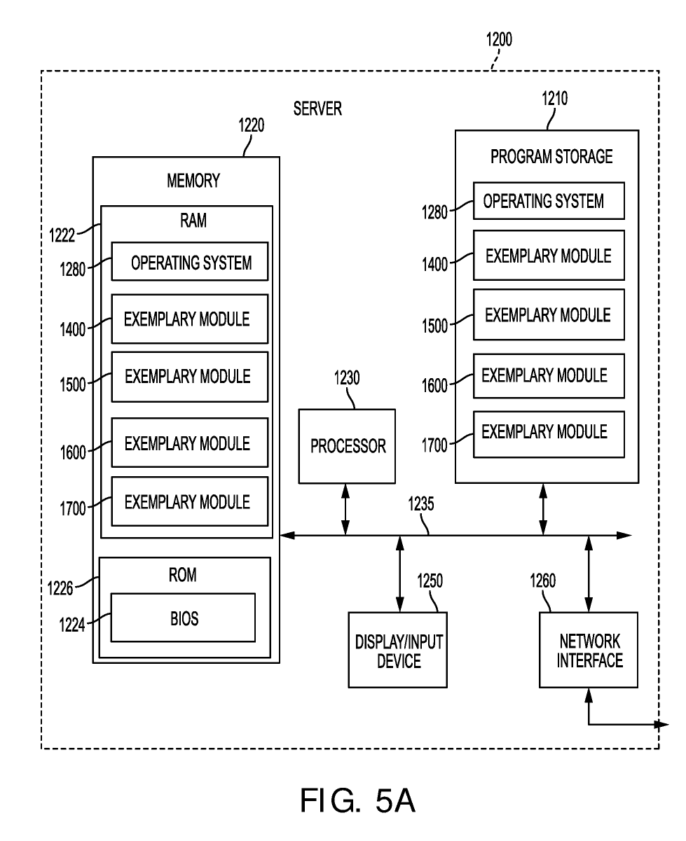

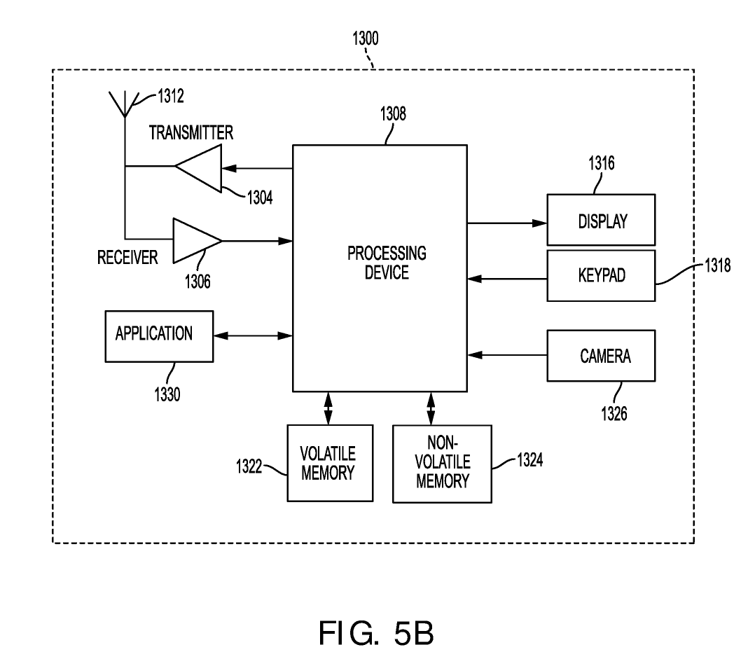

FIG. 5A is a schematic diagram of the server 1200 according to various embodiments. The server 1200 includes a processor 1230 that communicates with other elements within the server via a system interface or bus 1235. Also included in the server 1200 is a display/input device 1250 for receiving and displaying data. This display/input device 1250 may be, for example, a keyboard or pointing device that is used in combination with a monitor. The server 1200 further includes memory 1220, which preferably includes both read only memory (ROM) 1226 and random access memory (RAM) 1222. The server's ROM 1226 is used to store a basic input/output system 1224 (BIOS), containing the basic routines that help to transfer information between elements within the server 1200. Various ROM and RAM configurations have been previously described herein.

In addition, the server 1200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 1210 are connected to the system bus 1235 by an appropriate interface. The storage devices 1210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 1210 and/or memory of the server 1200 may further provide the functions of a data storage device, which may store historical and/or current delivery data and delivery conditions that may be accessed by the server. In this regard, the storage device 1210 may comprise one or more databases. The term “database” refers to a structured collection of records or data that is stored in a computer system, such as via a relational database, hierarchical database, or network database and as such, should not be construed in a limiting fashion.

A number of program modules (e.g., exemplary modules 1400-1700) comprising, for example, one or more computer-readable program code portions executable by the processor 1230, may be stored by the various storage devices 1210 and within RAM 1222. Such program modules may also include an operating system 1280. In these and other embodiments, the various modules 1400, 1500, 1600, 1700 control certain aspects of the operation of the server 1200 with the assistance of the processor 1230 and operating system 1280. In still other embodiments, it should be understood that one or more additional and/or alternative modules may also be provided, without departing from the scope and nature of the present invention.

In various embodiments, the program modules 1400, 1500, 1600, 1700 are executed by the server 1200 and are configured to generate one or more graphical user interfaces, reports, instructions, and/or notifications/alerts, all accessible and/or transmittable to various users of the system 1020. In certain embodiments, the user interfaces, reports, instructions, and/or notifications/alerts may be accessible via one or more networks 1130, which may include the Internet or other feasible communications network, as previously discussed.

In various embodiments, it should also be understood that one or more of the modules 1400, 1500, 1600, 1700 may be alternatively and/or additionally (e.g., in duplicate) stored locally on one or more of the devices 1110, 1120, and/or 1300 and may be executed by one or more processors of the same. According to various embodiments, the modules 1400, 1500, 1600, 1700 may send data to, receive data from, and utilize data contained in one or more databases, which may be comprised of one or more separate, linked and/or networked databases.

Also located within the server 1200 is a network interface 1260 for interfacing and communicating with other elements of the one or more networks 1130. It will be appreciated by one of ordinary skill in the art that one or more of the server 1200 components may be located geographically remotely from other server components. Furthermore, one or more of the server 1060 components may be combined, and/or additional components performing functions described herein may also be included in the server.

While the foregoing describes a single processor 1230, as one of ordinary skill in the art will recognize, the server 1200 may comprise multiple processors operating in conjunction with one another to perform the functionality described herein. In addition to the memory 1220, the processor 1230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 1200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 1200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

FIG. 5B provides an illustrative schematic representative of a mobile device 1300 that can be used in conjunction with various embodiments of the present invention. Mobile devices 1300 can be operated by various parties. As shown in FIG. 5B, a mobile device 1300 may include an antenna 1312, a transmitter 1304 (e.g., radio), a receiver 1306 (e.g., radio), and a processing element 1308 that provides signals to and receives signals from the transmitter 1304 and receiver 1306, respectively.

The signals provided to and received from the transmitter 1304 and the receiver 1306, respectively, may include signaling data in accordance with an air interface standard of applicable wireless systems to communicate with various entities, such as the server 1200, the distributed devices 1110, 1120, and/or the like. In this regard, the mobile device 1300 may be capable of operating with one or more air interface standards, communication protocols, modulation types, and access types. More particularly, the mobile device 1300 may operate in accordance with any of a number of wireless communication standards and protocols. In a particular embodiment, the mobile device 1300 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 1300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 1300 can also download changes, add-ons, and updates, for instance, to its firmware, software (e.g., including executable instructions, applications, program modules), and operating system.

According to one embodiment, the mobile device 1300 may include a location determining device and/or functionality. For example, the mobile device 1300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 1300 may also comprise a user interface (that can include a display 1316 coupled to a processing element 1308) and/or a user input interface (coupled to a processing element 1308). The user input interface can comprise any of a number of devices allowing the mobile device 1300 to receive data, such as a keypad 1318 (hard or soft), a touch display, voice or motion interfaces, or other input device. In embodiments including a keypad 1318, the keypad can include (or cause display of) the conventional numeric (0-9) and related keys (#, *), and other keys used for operating the mobile device 1300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 1300 can also include volatile storage or memory 1322 and/or non-volatile storage or memory 1324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMIVI, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 1300.

The mobile device 1300 may also include one or more of a camera 1326 and a mobile application 1330. The camera 1326 may be configured according to various embodiments as an additional and/or alternative data collection feature, whereby one or more items may be read, stored, and/or transmitted by the mobile device 1300 via the camera. The mobile application 1330 may further provide a feature via which various tasks may be performed with the mobile device 1300. Various configurations may be provided, as may be desirable for one or more users of the mobile device 1300 and the system 1020 as a whole.

It should be understood that the present invention is not limited to the above-described embodiments and many modifications are possible within the scope of the following claims. Such modifications may, for example, involve using a different source of energy beam than the exemplified electron beam such as a laser beam. Additionally or otherwise, materials other than metallic powder may be used, such as the non-limiting examples of powder of polymers or powder of ceramics.

1. A method for forming a three-dimensional article through successively depositing individual layers of powder material that are fused together so as to form the three-dimensional article in a vacuum chamber, said method comprising the steps of:
emitting, via at least one electron beam source, an electron beam for at least one of heating or fusing said powder material in said vacuum chamber,
applying a first set of beam parameters for formation of a fused bulk material of said three-dimensional article, where said bulk material of said three-dimensional article exhibits a predetermined microstructure, and
applying a second set of beam parameters for formation of a top portion of said three-dimensional article, wherein said second set of beam parameters has a higher power per unit time and unit area than said first set of beam parameters and is applied a predetermined number of layers prior to reaching a top surface of said three-dimensional article for encapsulating chimney porosities into said bulk material.

2. The method according to claim 1, further comprising the step of performing a HIP process step for removing cavities in said three-dimensional article.

3. The method according to claim 1, wherein said first and second sets of beam parameters are at least one of a group of: beam focus, beam scanning speed, beam line offset, beam power, and beam on-off switching frequency.

4. The method according to claim 1, wherein the at least one electron beam source comprises a first electron beam source and a second electron beam source, wherein the first electron beam source is used for melting the bulk material and the second electron beam source is used for melting said top surface and said predetermined layers prior to said top surface.

5. The method according to claim 1, wherein said predetermined number of layers prior to said top surface is less than 10 layers.

6. The method according to claim 1, wherein the same beam parameters are used for said top surface and all said predetermined layers prior to said top surface.

7. The method according to claim 1, wherein different beam parameters are used for said top surface as compared to all said predetermined layers prior to said top surface.

8. The method according to claim 1, wherein a first electron beam source is used for melting bulk material and an additional melting source are used for melting said top surface and said predetermined layers prior to said top surface.

9. The method according to claim 8, wherein said additional source is either an IR-source or a resistive source.

10. The method according to claim 4, wherein the first electron beam source is emitting a continuous electron beam and the second electron beam source is emitting a pulsed electron beam.

11. The method according to claim 10, wherein said pulsed electron beam source is used for said bulk material and said continuous electron beam source is used for said top surface and said predetermined layers prior to said top surface.

12. The method according to claim 11, wherein said pulsed and continuous electron beams are emanating from one and the same electron beam source.

13. The method according to claim 4, wherein said first electron beam source is emitting a pulsed electron beam with a first frequency and said second electron beam source is emitting an electron beam source with a second frequency.

14. The method according to claim 4, wherein said first and said second electron beam sources emanate pulsed electron beams, wherein said electron beams are pulsed synchronously when melting said top surface and said predetermined layers prior to said top surface.

15. The method according to claim 4, wherein said first and said second electron beam sources emanate pulsed electron beams, wherein said electron beams are pulsed non-synchronously when melting said top surface and said predetermined layers prior to said top surface.

16. The method according to claim 1, wherein:
the first set of beam parameters and the second set of beam parameters are stored in and retrieved from one or more memory storage areas; and
at least one of the emitting and applying steps are executed via at least one computer processor.

17. A computer-implemented method for forming a three-dimensional article through successively depositing individual layers of powder material that are fused together so as to form the three-dimensional article in a vacuum chamber, said method comprising the steps of:
providing in one or more memory storage areas a first set of beam parameters and a second set of beam parameters; and
via one or more computer processors:
emitting an electron beam from at least one electron beam source, the electron beam being configured for at least one of heating or fusing said powder material in said vacuum chamber,
applying the first set of beam parameters to form a fused bulk material of said three-dimensional article, where said bulk material of said three-dimensional article exhibits a predetermined microstructure, and
applying the second set of beam parameters to form a top portion of said three-dimensional article, wherein said second set of beam parameters has a higher power per unit time and unit area than said first set of beam parameters and is applied a predetermined number of layers prior to reaching a top surface of said three-dimensional article for encapsulating chimney porosities into said bulk material.

18. An apparatus for forming a three-dimensional article through successively depositing individual layers of powder material that are fused together so as to form the three-dimensional article in a vacuum chamber, said apparatus comprising:
one or more memory storage areas containing a first set of beam parameters and a second set of beam parameters;
at least one electron beam source configured to emit an electron beam; and
one or more computer processors configured for:
emitting the electron beam so as to at least one of heat or fuse said powder material in said vacuum chamber,
applying the first set of beam parameters to form a fused bulk material of said three-dimensional article, wherein said bulk material of said three-dimensional article exhibits a predetermined microstructure, and
applying the second set of beam parameters to form a top portion of said three-dimensional article, wherein said second set of beam parameters has a higher power per unit time and unit area than said first set of beam parameters and is applied a predetermined number of layers prior to reaching a top surface of said three-dimensional article for encapsulating chimney porosities into said bulk material.

19. The apparatus according to claim 18, wherein said first and second sets of beam parameters are at least one of a group of: beam focus, beam scanning speed, beam line offset, beam power, and beam on-off switching frequency.

20. The apparatus according to claim 18, wherein the at least one electron beam source comprises a first electron beam source and a second electron beam source, wherein the first electron beam source is used for melting the bulk material and the second electron beam source is used for melting said top surface and said predetermined layers prior to said top surface.

21. The apparatus according to claim 18, wherein a first electron beam source is used for melting bulk material and an additional melting source are used for melting said top surface and said predetermined layers prior to said top surface.

22. The apparatus according to claim 20, wherein the first electron beam source is emitting a continuous electron beam and the second electron beam source is emitting a pulsed electron beam.

23. The apparatus according to claim 20, wherein said first and said second electron beam sources emanate pulsed electron beams, wherein said electron beams are pulsed synchronously when melting said top surface and said predetermined layers prior to said top surface.

24. The apparatus according to claim 20, wherein said first and said second electron beam sources emanate pulsed electron beams, wherein said electron beams are pulsed non-synchronously when melting said top surface and said predetermined layers prior to said top surface.

25. A computer program product comprising at least one non-transitory computer-readable storage medium having computer-readable program code portions embodied therein, the computer-readable program code portions comprising at least one executable portion configured for:
emitting an electron beam from at least one electron beam source, the electron beam being configured for at least one of heating or fusing powder material in a vacuum chamber, so as to through successively depositing individual layers of said powder material form a three-dimensional article,
applying a first set of beam parameters to form a fused bulk material of said three-dimensional article, where said bulk material of said three-dimensional article exhibits a predetermined microstructure, and
applying a second set of beam parameters to form a top portion of said three-dimensional article, wherein said second set of beam parameters has a higher power per unit time and unit area than said first set of beam parameters and is applied a predetermined number of layers prior to reaching a top surface of said three-dimensional article for encapsulating chimney porosities into said bulk material.
